(19) United States
(12) Patent Application Publication
(10) Pub. No.: US 2007/0077443 A1
(43) Pub. Date: Apr. 5, 2007

(54) Adhesion promoter for elastomer/elastomer adherence

(75) Inventors: Stephen O'Rourke, Bolingbrook, IL (US); Kimberly L. Stefanisin, Oak Lawn, IL (US); John English, Oak Lawn, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: CPH INNOVATIONS CORP., Chicago, IL (US)

(21) Appl. No.: 11/607,424

(22) Filed: Dec. 1, 2006

Related U.S. Application Data
(63) Continuation-in-part of application No. 10/811,510, filed on Mar. 29, 2004.
(63) Continuation-in-part of application No. 10/616,658, filed on Jul. 10, 2003, now Pat. No. 7,109,264.
(63) Continuation-in-part of application No. 10/718,233, filed on Nov. 19, 2003, now Pat. No. 7,144,937.
Application No. 10/718,233 is a continuation-in-part of application No. 10/434,616, filed on May 9, 2003, now Pat. No. 6,858,664.
Application No. 10/718,233 is a continuation-in-part of application No. 10/435,212, filed on May 9, 2003, now Pat. No. 6,969,737.
Application No. 10/434,616 is a continuation-in-part of application No. 10/301,770, filed on Nov. 21, 2002, now abandoned.
Application No. 10/434,616 is a continuation-in-part of application No. 10/144,229, filed on May 10, 2002, now Pat. No. 6,884,832.
Application No. 10/435,212 is a continuation-in-part of application No. 10/301,770, filed on Nov. 21, 2002, now abandoned.
Application No. 10/435,212 is a continuation-in-part of application No. 10/144,229, filed on May 10, 2002, now Pat. No. 6,884,832.
(60) Provisional application No. 60/458,648, filed on Mar. 28, 2003.
(60) Provisional application No. 60/460,903, filed on Apr. 7, 2003.

(51) Int. Cl. B32B 27/00

(52) U.S. Cl. 428/500

(57) ABSTRACT

Long chain esters formed by reacting mono, di-, and/or tri-carboxylic acids containing one, two, or three C₆-C₂₄ long chain radicals or fatty acid residues, and alcohols containing at least one C₃-C₂₄ alkyl group, in a natural or synthetic vulcanizable or cross-linkable elastomer or rubber, when included with an adhesive resin, such as a melamine-containing resin or a phenol-, e.g., resorcinol-containing resin, e.g., a Novolak resin, unexpectedly increases the adhesion of one rubber or elastomer layer to another rubber or elastomer layer, even when the rubber/elastomer layers have substantially different polarities. Application of the adhesion promoters described herein is particularly contemplated for adhering one or more layers of difficulty adhered elastomers, such as fluorinated elastomers, to themselves, or to other elastomer layers that have similar or substantially different polarities.

### CROSS REFERENCE TO RELATED APPLICATIONS

This is a continuation-in-part of U.S. patent application Ser. No. 10/811,510, filed Mar. 29, 2004 which claims benefit of U.S. Provisional Applications 60/458,648, filed Mar. 28, 2003 and 60/460,903, filed Apr. 7, 2003. This application also is a continuation-in-part of U.S. patent application Ser. No. 10/616,658, filed Jul. 10, 2003; and a continuation-in-part of U.S. patent application Ser. No. 10/718,233, filed Nov. 19, 2005, which is a continuation-in-part of U.S. patent application Ser. No. 10/434,616, filed May 9, 2003, now U.S. Pat. No. 6,858,664, and U.S. patent application Ser. No. 10/435,212, filed May 9, 2003, now U.S. Pat. No. 6,969,737, which are both continuations-in-part of U.S. patent application Ser. No. 10/301,770, filed Nov. 21, 2002, and U.S. patent application Ser. No. 10/144,229, filed May 10, 2002, now U.S. Pat. No. 6,884,832, the entire respective disclosures of which are hereby incorporated by reference.

### FIELD OF THE INVENTION

The present invention is directed to multi-ply articles and methods for adhering similar or dissimilar cured, cross-linked or vulcanized elastomeric articles to each other, including natural and/or synthetic rubbers; silicone polymers; acrylic polymers; urethane polymers; chemically modified elastomers, such as halogen-modified elastomers, e.g., fluorinated elastomers; and thermoplastic elastomers (TMPs) using adhesion promoters that are a combination of long chain esters and adhesive resins. The multi-ply elastomeric articles can be used in the manufacture of tires, hoses, conveyor belts, rubber matting, carpet matting, O-rings, stem packing, choke packing, T-seals, S-seals, V-packing, valve seals, valve seats, piston cups, rod wipers, flange seals, pump and valve diaphragms, flexible plumbing connectors, window and door seals, weather stripping, cable covers, automotive parts; sporting goods, transmission belts, chemical attack-resistant linings for mixing vessels, conduits, and the like.

### BACKGROUND

Many elastomeric, e.g., rubber articles, principally automobile tires, but also including hoses, conveyor belts, power train belts, e.g., transmission belts, chemical attack-resistant linings for mixing vessels, conduits, and the like, are manufactured to include a plurality of elastomer layers adhered together. The articles and methods using the adhesion promoters described herein are useful to adhere a plurality of elastomer layers together when manufacturing all of the above-described rubber articles.

### SUMMARY

In brief, it has been found that the use of a combination of long chain esters and adhesive resins, to adhere elastomeric articles together, provides a durable and structurally secure bond between a plurality of elastomer layers.

Surprisingly good adhesion has been found for adhering multiple layers of elastomers or rubbers to each other by adding an adhesive resin and one or more long chain mono-, di-, and/or tri-esters, particularly dimerate esters reacted from C₁₈ dimer and/or trimer fatty acids, and C₃-C₂₄ alcohols, preferably, C₆-C₂₄ alcohols, more preferably C₆-C₁₈ alcohols. The esters provide unexpected, tenacious bonding between adjacent layers of elastomers and/or rubbers, when combined with the adhesive resin.

In one embodiment, the esters and/or adhesives resins can be added as a solid or liquid, (sorbed in a solid inert carrier, or as a liquid dissolved in a suitable solvent or emulsified in water) to the elastomer composition during forming of the cross-linked or vulcanized elastomeric articles to be adhered together. In other embodiments, the ester and adhesive resin can be added after the elastomeric articles are formed, cross-linked and/or vulcanized, and surface coated as a liquid (solubilized in an appropriate organic solvent, or as a water emulsion) between adjacent elastomer article layers to be adhered together. In still another embodiment, the ester and adhesive resin are combined with one or more reactive diluents. It is theorized that the long chain esters described here strongly adhere to both elastomer and/or rubber layers and to the resin, between adjacent elastomer and/or rubber layers.

### DETAILED DESCRIPTION OF THE PREFERRED EMBODIMENTS

The adhesion promoters described herein, being a combination of the esters described herein together with one or more adhesive resins, include at least one long chain ester compound and at least one adhesive resin. The adhesion promoter systems are useful for improving the adhesion of layers of rubber to rubber; rubber to elastomer; and elastomer to elastomer. Surprisingly, the adhesion promoters described herein significantly increase the adhesion of layers of rubber and/or elastomer whether the combination is applied to the surface of one or both elastomer/rubber layers, or included with the rubber composition that is cross-linked and/or vulcanized when forming the layers to be adhered together. In the description, the terms “adhesion promoter system” and “adhesion promoter” may be used interchangeably.

In the adhesion promoter systems described herein, long chain esters may be added to natural or synthetic elastomer and/or rubber with a vulcanizing agent and an adhesive resin, or the ester/adhesive resin combination (as a liquid or emulsion) may be coated (continuously or discontinuously) onto one or both of the elastomer and/or rubber layers to be adhered together. The adhesion promoter system may be added to one or more elastomers and/or natural rubber(s) and/or synthetic rubber(s), as a neat liquid, in order to promote adhesion. Typically, however, the adhesion promoters are mixed with a dry carrier, such as calcium silicate, to form an alternative delivery system, which can be incorporated into natural and/or synthetic rubber(s). In such a method, the carrier facilitates delivery of the active adhesion promoting agents to the elastomer(s) and/or rubber(s). In yet another refinement, the adhesion promoter may be formulated as a “polymer masterbatch.” According to this aspect, a pellet comprising elastomer (about 6 wt. % to about 20 wt. %), filler or inert ingredients (about 0 wt. % to about 14 wt. %), with the balance being an adhesion promoter system (i.e., at least one ester compound in accordance with formulas I-IV and at least one adhesive resin such as melamine) is added to an elastomer and/or natural or synthetic rubber. Typically, the masterbatch polymer and the elastomer or rubber to which the masterbatch polymer is added are miscible. Preferably, the masterbatch polymer and the elastomer or rubber are the same.

Throughout the specification, the adhesion promoter systems, when added to the pre-vulcanized elastomer or rubber composition, are generally used in an amount between about 0.2% by weight and about 30% by weight. Typically, each component of the adhesion promoter system described herein (i.e., an ester in accordance with formulas I-IV and an adhesive resin) is present in an amount between about 0.1% and about 15% by weight, usually between about 1 wt. % and about 10 wt. %, and most preferably between about 2 wt. % and about 8 wt. %, based on the weight of elastomer, natural and/or synthetic rubber in the composition.

Typically, in the sealant compositions according to the invention, long chain esters are typically added with an adhesive resin. According to one aspect of this embodiment, the adhesion promoter systems may be added to a sealant(s) as a liquid in order to promote adhesion of one elastomeric article to another elastomeric article. For example, the adhesive resin(s) and long chain ester(s) are solubilized in one or more suitable organic solvents. Alternatively, the adhesive resin(s) and long chain ester(s) can be emulsified in water with one or more suitable emulsifying agents to form a water-based emulsion.

The water-based emulsions should have an HLB value of about 4 to about 5 for best ester dispersion in the emulsion. In liquid form, the adhesion promoter has a number of advantages, particularly the ability to coat or pre-treat an elastomeric substrate with the liquid ester/resin adhesion promoter for increased adherence of adjacent, contacting elastomers. Other advantages include (1) the ability to prepare a relatively high concentration solution of the adhesion promoter, e.g., 50-90% by weight of the adhesion promoter, which can be diluted upon addition to an elastomer article surface or to a not yet vulcanized elastomer composition; (2) the ability to include excess alcohol, e.g., 2-ethylhexanol, during the synthesis of the long chain ester portion of the liquid adhesion promoter, for use as a solvent for solubilizing the resin portion of the liquid adhesion promoter. The use of excess alcohol during the synthesis of the esters is particularly advantageous for ester synthesis since the esterification reaction proceeds faster with excess alcohol. Since the excess alcohol is useful in solubilizing the resin, the excess alcohol can remain with the synthesized ester without removing much, or any, of the excess alcohol in an ester concentration or purification step. The liquid adhesion promoter, whether solubilized in an organic liquid or emulsified in a water-based emulsion, can be added directly to the elastomer and/or rubber composition for the manufacture of a vulcanized elastomeric article that can adhere to another elastomeric or rubber article or can be used to pre-treat, e.g., coat, the vulcanized elastomeric article for adhering the article to another elastomeric article or layer.

In accordance with another embodiment, it has also been found that the addition of one or more reactive organic solvents (reactive diluents) to the elastomer compositions or ester/adhesive resin compositions described herein, in addition to a solvent used to solubilize the adhesive resin, or as a replacement for any portion of the resin solvent or all of the resin solvent, unexpectedly increases the adhesion of the elastomeric articles to another layer of a similar or dissimilar elastomeric article.

Examples of suitable reactive diluents include (1) glycidyl ethers, (2) diglycidyl ethers; (3) aliphatic, straight chain epoxides; (4) epoxidized vegetable oils, particularly epoxidized soybean oil; (5) cycloaliphatic epoxies; (6) glycidyl esters, and (7) diglycidyl esters.

(1) Glycidyl ethers generally have a structural formula as follows: 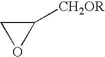
where R is alkyl (e.g., methyl, ethyl, butyl, isobutyl, and the like), alkyl containing one or more olefinic bonds, or aryl (e.g., phenyl, toluyl, benzyl, and the like). Such species include reaction products of epichlorohydrin with methanol, ethanol, isopropanol, n-butanol, 1-octanol, 2-ethylhexanol, n-decanol, isooctanol, isodecanol, oleyl alcohol, benzyl alcohol, or any other alcohol, as well as mixtures of alcohols, for example, a mixture of n-octyl and n-decyl.)

Examples include 2-ethylhexyl glycidyl ether; allyl glycidyl ether; dodecyl glycidyl ether; decyl glycidyl ether; iso-butyl glycidyl ether; n-butyl glycidyl ether; naphthyl glycidyl ether; tridecyl glycidyl ether; phenyl glycidyl either; 2-ethylhexyl glycidyl ether; C₈-C₁₀ aliphatic glycidyl ether; p-tertiarybutylphenyl glycidyl ether; nonylphenyl glycidyl ether; and phenyl glycidyl ether.

(2) Diglycidyl ethers generally have a structural formula as follows: 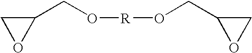
where R is a straight chain or branched aliphatic moiety, for example (CH₂)ₙ, where n=2-10, e.g., —CH₂—CH(CH₃)CH₂—, —CH₂—C(CH₃)₂—CH₂—, and the like. These species include reaction products of epichlorohydrin with a diol or mixtures of diols, such as ethylene glycol, propylene glycol, 1,4-butylene glycol, 1,3-butylene glycol, 1,6-hexanediol, 2-methyl-1,3-propanediol, 2,2-dimethyl-1,3-propanediol, and mixtures thereof. R can also be an aromatic moiety, resulting in an epoxy structure that is the reaction product of glycidol with common bisphenols such as bisphenol A and bisphenol F.

Examples include 1,6-hexanediol diglycidyl ether; bisphenol A diglycidyl ether; neopentyl glycol diglycidyl ether; 1,4 butanediol diglycidyl ether; cyclohexanedimethanol diglydidyl ether; polypropylene glycol diglycidyl ether; polyethyleneglycol diglycidyl ether; dibromoneopentyl glycol diglycidyl ether; trimethylopropane triglycidyl ether; castor oil triglycidyl ether; propoxylated glycerin triglycidyl ether; and sorbitol polyglycidyl ether.

(3) Aliphatic, straight chain epoxides have a general structural formula as follows:

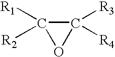

Examples include propylene oxide, butylene oxide, as well as the following:

| R₁ | R₂ | R₃ | R₄ |
|---|---|---|---|
| CH₂══CH | H | H | H |
| C₃H₇ | H | H | H |
| (CH₃)₂CH | H | H | H |
| C₅H₁₁ | H | H | H |
| C₆H1₃ | H | H | H |
| (CH₃)₂CH(CH₂)₃ | H | H | H |
| C₈H₁₇ | H | H | H |
| C₁₆H₃₃ | H | H | H |
| C₁₈H₃₇ | H | H | H |
| C₆H₅ | H | H | H |
| C₆H₅CH₂ | H | H | H |
| C₆H₅(CH₂)₂ | H | H | H |
| C₆H₅(CH₂)₃ | H | H | H |
| C₅H₅(CH₂)₄ | H | H | H |
| CH₂OH | H | H | H |
| CH₃OCH₂ | H | H | H |
| C₂H₅OCH₂ | H | H | H |
| C₃H₇CHOH | H | H | H |
| C₆H₅OCH₂ | H | H | H |
| CH₃CO₂CH₂ | H | H | H |
| CH₂══CHCO₂CH₂ | H | H | H |
| CH₂══C(CH₃)—CO₂CH₂ | H | H | H |
| CH₃CH══CH—CO₂CH₇ | H | H | H |
| Br | H | H | H |
| CH₂F | H | H | H |
| CH₂Cl | H | H | H |
| CH₂Br | H | H | H |
| CH₂I | H | H | H |
| CF₃ | H | H | H |
| CCl₃ | H | H | H |
| (C₂H₅)₂NCH₂ | H | H | H |
| C₂H₅ | H | C₂H₅ | H |
| C₂H₅ | H | CF₃ | H |
| C₂H₅ | H | C₃F₇ | H |
| C₄H₉ | H | CH₂Br | H |
| C₅H₁₁ | H | Cl | H |
| C₆H₅ | H | CH₃ | H |
| C₆H₅ | H | C₂H₅ | H |
| C₆H₅ | H | C₃H₇ | H |
| C₆H₅ | H | C₃H₇ (iso) | H |
| C₆H₅ | H | C₆H₅CH₂ | H |
| CF₃ | H | F | H |
| CH₃ | CH₃ | CH₃ | H |
| CH₃ | C₂H₅ | CH₃ | H |
| CH₃ | CH₃ | C₃F₇ | H |
| CH₃ | CH₃ | CO₂C₂H₅ | H |
| CH₃ | CF₃ | Cl | H |
| C₂H₅ | C₂H₅ | OH₃ | H |
| CH₃ | CH₃ | CH₃ | CH₃ |
| CH₃ | CH₃ | H | H |
| CH₃ | CF₃ | H | H |
| CH₃ | C₂H₅ | H | H |
| CH₃ | C₃F₇ | H | H |
| C₂H₅ | CH₂Br | H | H |
| C₆H₅ | CH₃ | H | H |
| C₆H₅(CH₂)₃ | CH₃ | H | H |
| C₆H₅ | OH | H | H |
| Cl | Cl | H | H |
| CH₃ | H | CH₃(cis) | H |
| CH₃ | H | H | CH₃(trans) |
| CH₃ | H | C₂H₅(cis) | H |
| CH₃ | H | H | C₇H₆(trans) |
| CH₃ | H | C₃H₇ | H |
| CH₃ | H | C₃H₇(iso) | H |
| CH₃ | H | CF₃ | H |
| CH₃ | H | CH₂Br | H |
| CH₃ | H | C₃F₇ | H |
| CH₃ | H | CO₂H | H |

(4) Epoxidized oils such as epoxidized soybean oil, epoxidized linseed oil, epoxidized safflower oil, epoxidized corn oil, epoxidized cottonseed oil, epoxidized rapeseed oil, epoxidized peanut oil, and other similar species derived from the epoxidation of C₁₈-unsaturated esters of glycerin can also be used as the reactive diluent.

(5) Cycloaliphatic epoxides, such as 1,2-cyclohexene oxide, 1,2-cyclopentene oxide, 1,2,3,4,-diepoxybutene, vinylcyclohexene dioxide, and the like, as well as those products marketed by Shell Oil under the brand name EPON®, an example of which is shown below.

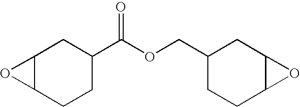

(6) Glycidyl esters generally have a structural formula as follows: 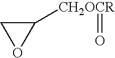
where R is a straight chain aliphatic, such as —(CH₂)ₙ—CH₃ (wherein n=1-9) or branched aliphatic such as —CH₂CH(CH₃)₂, —CH(CH₂CH₃)(CH₂)₄CH₃, and the like. R can also be contain one or more olefinic bonds. R can also be aromatic, i.e., -phenyl or -toluyl. These glycidyl esters include reaction products of glycidol with carboxylic acids, such as acetic acid, propionic acid, isobutyric acid, 2-ethylhexoic acid, benzoic acid, toluic acid (various isomers), oleic acid, linoleic acid, linolenic acid, as well as mixtures of carboxylic acids. Preferably, the reaction with glycidol is with the methyl esters of the carboxylic acids (e.g., trans-esterification).

Examples include glycidyl neodecanoate; acetic acid glycidyl ester; butyric acid glycidyl ester; propionic acid glycidyl ester; valeric acid glycidyl ester; caproic acid glycidyl ester; capric acid glycidyl ester; caprylic acid glycidyl ester; lauric acid glycidyl ester; and glycidyl ester of linoleic acid or of linolenic acid.

(7) Diglycidyl esters generally have a structural formula as follows:

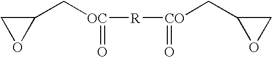

Where R is straight chain aliphatic —(CH₂)ₙ wherein n is typically between 1 and 8, or branched aliphatic, or aliphatic/cycloaliphatic mixed, or aliphatic containing one or more olefinic bonds. R can also be aromatic. These diglycidyl esters include reaction products of glycidol with dicarboxylic acids such as malonic acid, glutaric acid, adipic acid, azelaic acid, sebacic acid, phthalic anhydride, isophthalic acid, terephthalic acid, and one or more dimer acids. Preferably, the reaction with glycidol is with the methyl esters of the carboxylic acids (e.g., trans-esterification).

In the reactive diluent embodiment described herein, the reactive diluent is typically included in an amount between about 0.5% and about 50% by weight, usually between about 5 wt. % and about 40 wt. %, and most preferably between about 10 wt. % and about 30 wt. %, based on the total weight of adhesion promoter (i.e., adhesive resin plus ester) in the elastomer composition. These reactive diluents function as solvents to compatibilize the sealant(s), adhesive resin, and long chain ester compositions described herein, and are believed to participate chemically in the adhesion of adjacent, elastomeric substrates.

In another embodiment, the cross-linked and/or vulcanized elastomeric substrate can be pretreated with the adhesive resin component of the adhesion promoter system. The resin-treated elastomeric substrate can subsequently be treated with the ester component of the adhesion promoter system for improved adherence of adjacent, elastomeric substrates. The resin-treated elastomeric substrate can be ester treated in any manner, preferably by dipping or coating the resin-treated elastomeric substrate with an organic solution of the ester or a water-based emulsion containing the ester. Alternatively, the ester component can be added to an elastomer composition prior to cross-linking or vulcanization, for subsequent interaction with the resin treated substrate formed from the elastomer composition. According to this embodiment of the invention, the term “sealant composition” refers to a combination of a sealant and an ester having Formulas I, II, III, IV, or combinations of any two or more of the esters.

The adhesion promoter systems can also be mixed with a preferably inert, dry carrier, such as calcium silicate, to form an alternative delivery system, which can be incorporated into the elastomer composition(s). In such systems, the dry, inert carrier facilitates delivery of the active adhesion promoting agents to the elastomer(s) formed from the elastomer composition.

As a hypothetical example, a representative adhesion promoter system utilizing a dry carrier, RX-13845, is prepared by adding preheated Cyrez CRA 138 resin liquid to a dry carrier contained in a mixing bowl, followed by addition of preheated RX-13804, a combination of representative long chain esters having formulas II and III. The materials are mixed at low speed for about 3 minutes. The materials are blended for an additional time period, approximately 3 minutes. RX-13845 is advantageous in that it permits liquids to be handled as powders. Because the active adhesion promoter is released from the carrier, incorporation of RX-13845 into an elastomer composition allows the adhesion promoter to function in the same manner as if it had been incorporated into the elastomer composition as a neat material.

In yet another embodiment of the invention, the adhesion promoters may be formulated as a “elastomer masterbatch.” According to this aspect of the invention, a pellet comprising a masterbatch elastomer (about 6 wt. % to about 20 wt. %), a filler or other similar inert ingredients (about 0 wt. % to about 14 wt. %), with the balance being an adhesion promoter system (i.e., at least one ester compound in accordance with formulas I-IV, preferably II-IV, and at least one adhesive resin, such as melamine) is added to an elastomer composition to improve adhesion of the formed, vulcanized elastomer layer to another vulcanized elastomer layer. Typically, the masterbatch elastomer and the initial elastomeric component of the elastomer, to which the masterbatch elastomer is added, are miscible. Preferably, the masterbatch elastomer and the initial elastomeric component of the elastomer composition are the same.

Throughout the specification, the adhesion promoter systems are generally used in an amount between about 0.2% by weight and about 30% by weight, based on the weight of the sealant(s) in the sealant composition(s). Typically, the ester and adhesive resin components of an adhesion promoter system of the invention are both present in an amount between about 0.1% and about 15% by weight, usually between about 1 wt. % and about 10 wt. %, and most preferably between about 2 wt. % and about 8 wt. %, based on the weight of the elastomer(s) in the elastomer composition.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The long chain esters may be monoesters, diesters, triesters, or mixtures thereof, that may include saturated or unsaturated hydrocarbon chains, straight chain or branched having none, one, two or three double bonds in the hydrocarbon chains.

The monoesters have a formula I, as follows: 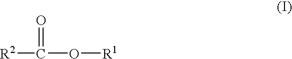
wherein R¹ is a C₃-C₂₄ alkyl, preferably C₃-C₁₈ alkyl, more preferably C₆-C₁₈ alkyl, straight chain or branched, saturated or unsaturated containing 1 to 3 carbon-to-carbon double bonds. R² is a C₃-C₂₄, preferably C₆-C₂₄, more preferably C₈-C₁₈ saturated hydrocarbon, or an unsaturated hydrocarbon having 1 to 6, preferably 1 to 3 carbon-to-carbon double bonds.

The diesters have a formula II or III, as follows: 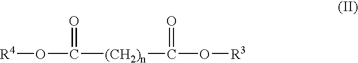
wherein n=3-24, preferably 6-18, and more preferably 3-10, and R³ and R⁴, same or different are C₃-C₂₄ alkyl, preferably C₃-C₁₈ alkyl, more preferably C₆-C₁₈ alkyl radicals, straight chain or branched, saturated or unsaturated containing 1 to 3 carbon-to-carbon double bonds. 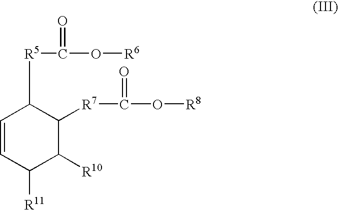
wherein R⁵ and R⁷, same or different, are C₃-C₂₄ alkyl, preferably C₆-C₂₄ alkyl, more preferably C₈-C₁₈ alkyl, straight chain or branched, either saturated or containing 1 to 6, preferably 1 to 3, carbon-to-carbon double bonds;
R⁶ and R⁸, same or different, are C₃-C₂₄ alkyl, preferably C₃-C₁₈ alkyl, more preferably C₆-C₁₈ alkyl, straight chain or branched, saturated or unsaturated containing 1 to 3 carbon-to-carbon double bonds; and
R¹⁰ and R¹¹, same or different, are C₃-C₂₄ saturated hydrocarbon chains, preferably C₃-C₁₈, more preferably C₆-C₁₈, straight chain or branched; or unsaturated C₃-C₂₄ hydrocarbon chains, preferably C₃-C₁₈, more preferably C₆-C₁₈, straight chain or branched, containing 1 to 6, preferably 1 to 3, carbon-to-carbon double bonds.

The triesters have a formula IV, as follows: 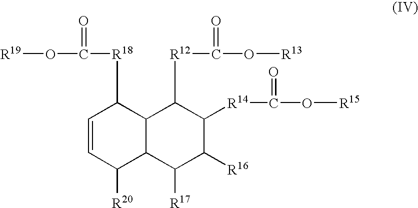
wherein R¹², R¹⁴ and R¹⁸, same or different, are C₃-C₂₄ alkyl, preferably C₆-C₂₄ alkyl, more preferably C₈-C₁₈ alkyl, straight chain or branched, either saturated or containing 1 to 6, preferably 1 to 3, carbon-to-carbon double bonds;
R¹³, R¹⁵ and R¹⁹, same or different, are C₃-C₂₄ alkyl, preferably C₃-C₁₈ alkyl, more preferably C₆-C₁₈ alkyl, straight chain or branched, saturated or unsaturated containing 1 to 3 carbon-to-carbon double bonds; and
R¹⁶, R¹⁷ and R²⁰, same or different, are C₃-C₂₄ saturated hydrocarbon chains, preferably C₃-C₁₈, more preferably C₆-C₁₈, straight chain or branched; or unsaturated C₃-C₂₄ hydrocarbon chains, preferably C₃-C₁₈, more preferably C₆-C₁₈, straight chain or branched, containing 1 to 6, preferably 1 to 3, carbon-to-carbon double bonds.

The fatty acid residues or hydrocarbon chains R², R⁵, R⁷, R¹², R¹⁴ and R¹⁸ of the esters of formulas I, II, III, and IV can be any C₃-C₂₄, preferably C₆-C₂₄, more preferably C₈-C₁₈, hydrocarbon chain, either saturated or containing 1 to 6, preferably 1 to 3, carbon-to-carbon double bonds, derived from animal or vegetable fatty acids such as butter; lard; tallow; grease; herring; menhaden; pilchard; sardine; babassu; castor; coconut; corn; cottonseed; jojoba; linseed; oiticica; olive; palm; palm kernel; peanut; rapeseed; safflower; soya; sunflower; tall; and/or tung. Examples are the hydrocarbon chain residues from the following fatty acids, where the number in parentheses indicates the number of carbon atoms, and the number of double bonds, e.g., (C₂₄₋₆) indicates a hydrocarbon chain having 24 carbon atoms and 6 double bonds: Hexanoic (C₆₋₀); Octanoic (C₈₋₀); Decanoic (C₁₀₋₀); Dodecanoic (C₁₂₋₀); 9-Dodecenoic (CIS) (C₁₂₋₁); Tetradecanoic (C₁₄₋₀); 9-Tetradecenoic (CIS) (C₁₄₋₁); Hexadecanoic (CIS) (C₁₆₋₀); 9-Hexadecenoic (CIS) (C₁₆₋₁); Octadecanoic (C₁₈₋₀); 9-Octadecenoic (CIS) (C₁₈₋₁); 9-Octadecenoic, 12-Hydroxy-(CIS) (C₁₈₋₂); 9, 12-Octadecadienoic (CIS, CIS) (C₁₈₋₂); 9, 12, 15 Octadecatrienoic (CIS, CIS, CIS) (C₁₈₋₃); 9, 11, 13 Octadecatrienoic (CIS, TRANS, TRANS) (C₁₈₋₃); 9, 11, 13 Octadecatrienoic, 4-Oxo (CIS, TRANS, TRANS) (C₁₈₋₃); Octadecatetrenoic (C₁₈₋₄); Eicosanoic (C₂₀); 11-Eicosenoic (CIS) (C₂₀₋₁); Eicosadienoic (C₂₀₋₂); Eicosatrienoic (C₂₀₋₃); 5, 8, 11, 14 Eicosatetraenoic (C₂₀₋₄); Eicosapentaenoic (C₂₀₋₅); Docosanoic (C₂₂); 13 Docosenoic (CIS) (C₂₂₋₁); Docosatetraenoic (C₂₂₋₄); 4, 8, 12, 15, 19 Docosapentaenoic (C₂₂₋₅); Docosahexaenoic (C₂₂₋₆); Tetracosenoic (C₂₄₋₄); and 4, 8, 12, 15, 18, 21 Tetracosahexaenoic (C₂₄₋₆).

Examples of particularly useful diesters of formula II include a saturated diester formed by the reaction of sebacic acid and 2-ethylhexyl alcohol: 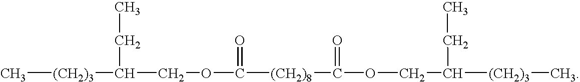
Other useful diesters falling within formula II include the saturated diester formed by the reaction of sebacic acid with tridecyl alcohol, 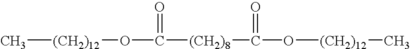
and the unsaturated diester formed by reaction of sebacic alcohol with oleyl alcohol:

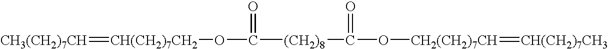

Useful cyclic diesters falling within formula III include dimerate ester structures formed by the reaction of a C₃₆ dimer acid derived from tall oil fatty acids and C₃-C₂₄, preferably C₃-C₁₈, more preferably C₆-C₁₈ alcohol, straight chain or branched, saturated or unsaturated containing 1 to 3 carbon-to-carbon double bonds. Examples of such cyclic esters include the following structures, wherein the dimer acid corresponding to structure A is formed by self reaction of linoleic acid, the dimer acid corresponding to structure B is formed by reacting linoleic acid with oleic acid, and the dimer acid corresponding to structure C is formed by reacting linoleic acid with linolenic acid: 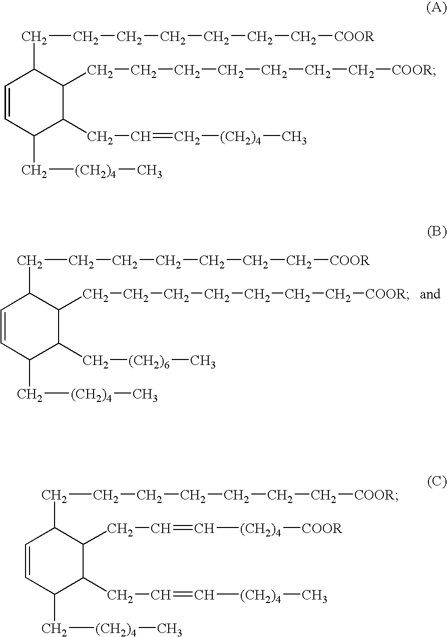
wherein each R, same or different, in formulas (A), (B), and (C) is a C₃-C₂₄ radical, preferably C₃-C₁₈, more preferably C₆-C₁₈, straight chain or branched, saturated or unsaturated containing 1 to 3 carbon-to-carbon double bonds. RX-13804 is another example of an unsaturated diester (dimerate ester) formed by the reaction of a predominantly C₃₆ dimer acid reacted with 2-ethylhexyl alcohol. RX-13824 is an additional unsaturated diester (dimerate ester) formed by the reaction of a predominantly C₃₆ dimer acid with tridecyl alcohol.

A representative example of the triester (trimerate ester) of formula IV is the following structure (D); 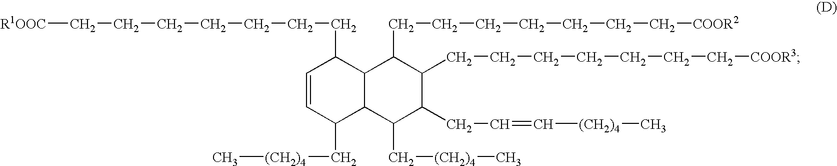
wherein each R¹, R², and R³, same or different, is a C₃-C₂₄ radical, preferably C₃-C₁₈, more preferably C₆-C₁₈, straight chain, or branched, saturated or unsaturated containing 1 to 3 carbon-to-carbon double bonds.

A particularly useful blend of long chain esters is formed from blends of mono, dimer, and trimer acids, for example, products having CAS#: 61788-89-4. Esters prepared from such products are blends including, primarily, the above C₃₆ and C₅₄ dimerate and trimerate esters (A), (B), (C) and (D), shown in the above structures, that is predominantly (more than 50% by weight) the C₃₆ dimerate esters (A), (B) and (C).

Commercially available blends of useful polybasic acids that can be reacted with C₃-C₂₄, preferably C₃-C₁₈, more preferably C₆-C₁₈ alcohols, straight chain or branched, saturated or unsaturated containing 1 to 3 carbon-to-carbon double bonds to produce the dimerate and trimerate esters, as blends, include the following: EMPOL® 1010 Dimer Acid; EMPOL® 1014 Dimer Acid; EMPOL® 1016 Dimer Acid; EMPOL® 1018 Dimer Acid; EMPOL® 1022 Dimer Acid; EMPOL® 1024 Dimer Acid; EMPOL® 1040 Trimer Acid; EMPOL® 1041 Trimer Acid; EMPOL® 1052 Polybasic Acid; and similar PRIPOL™ products from Uniqema as well as UNIDYME® products from Arizona Chemical.

Particularly useful long chain ester additives are made by reacting any of the long chain mono, dimer and/or trimer acids with one or more straight chain or branched C₃-C₂₄, preferably C₃-C₁₈, more preferably C₆-C₁₈ alcohols to produce the esters of formulas I, II, III and IV. The above dimer, trimer, and polybasic acids are produced by dimerizing, trimerizing, and polymerizing (oligomerizing) long chain carboxylic acids from the above-mentioned fatty acids. The fatty acids may be mixtures. Accordingly, the dimer acid produced by dimerizing a C₁₈ carboxylic acid (typically, a mixture of stearic, oleic, linoleic, and linolenic), after esterification, will result in a blend of numerous dimerate and trimerate esters in accordance with formulas III and IV, including saturated and unsaturated esters (i.e., some long chain esters may contain hydrocarbon chains having 1 to 6, generally 1 to 3, carbon-to-carbon double bonds). Any one, or any blend, of the esters of formulas I, II, III and/or IV, when combined with an adhesive resin, will function to increase the adhesion of natural or synthetic rubber to metal or polymeric cord, metal or polymeric substrates, such as polymeric woven or non-woven fabrics, and metal flat stock materials.

The adhesion promoters include an adhesive resin, which preferably is a condensation product of a formaldehyde or methylene donor and a formaldehyde or methylene acceptor, either pre-condensed, or condensed in-situ while in contact with the rubber. The term “methylene donor” is intended to mean a compound capable of reacting with a methylene acceptor (such as resorcinol or its equivalent containing a reactive hydroxyl group) and generate the resin outside of the rubber composition, or in-situ. Preferably, the components of the condensation product include a methylene acceptor and a methylene donor. The most commonly employed methylene acceptor is a phenol, such as resorcinol, while the most commonly employed methylene donor is a melamine, such as N-(substituted oxymethyl)melamine. The effect achieved is resin formation in-situ during vulcanization of the rubber, creating a bond between the metal or polymeric cords and the rubber, irrespective of whether the cords have been pretreated with an additional adhesive, such as a styrene-butadiene latex, polyepoxides with a blocked isocyanate, and the like. The long chain ester additive/resin combinations described herein are particularly useful with steel cord, where adhesive pretreatment has been largely ineffective.

Examples of methylene donors which are suitable for use in the rubber compositions disclosed herein include melamine, hexaniethylenetetramine, hexaethoxymethylmelamine, hexamethoxymethylmelamine, lauryloxymethyl-pyridinium chloride, ethoxy-methylpyridinium chloride, trioxan hexamethoxy-methylmelamine, the hydroxy groups of which may be esterified or partly esterified, and polymers of formaldehyde, such as paraformaldehyde. In addition, the methylene donors may be N-substituted oxymethylmelamines, of the general formula: 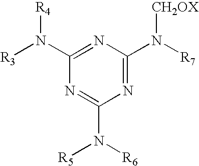
wherein X is an alkyl having from 1 to 8 carbon atoms R³, R⁴, R⁵, R⁶ and R⁷ are individually selected from the group consisting of hydrogen, an alkyl having from 1 to 8 carbon atoms and the group —CH₂OX. Specific methylene donors include hexakis(methoxymethyl)melamine; N,N′,N″trimethyl/N,N′,N″-trimethylol-melamine; hexamethylolmelamine; N,N′,N″-dimethylolmelamine; N-methylol-melamine; NN′-dimethylolmelamine; N,N′,N″-tris(methoxymethyl)melamine; and N,N′,N″-tributyl-N,N′,N″-trimethylol-melamine. The N-methylol derivatives of melamine are prepared by known methods.

The amount of methylene donor and methylene acceptor, pre-condensed or condensed in-situ, that are present in the rubber composition may vary. Typically, the amount of pre-condensed methylene donor and methylene acceptor is present will range from about 0.1% to about 15.0%; or each can be added separately in an amount of about 0.1% to about 10.0%, based on the weight of natural and/or synthetic rubber in the composition. Preferably, the amount of each of a methylene donor and methylene acceptor added for in-situ condensation ranges from about 2.0% to about 5.0%, based on the weight of natural and/or synthetic rubber in the composition. The weight ratio of methylene donor to the methylene acceptor may vary. Generally speaking, the weight ratio will range from about 1:10 to about 10:1. Preferably, the weight ratio ranges from about 1:3 to 3:1.

Resorcinol-free vulcanizable rubber compositions also are useful in the rubber compositions described herein. For example, resorcinol-free adhesive resins and adhesive compounds useful in the adhesion promoter systems (i.e., when combined with the long chain esters described herein) include those described in U.S. Pat. Nos. 5,891,938 and 5,298,539, both hereby incorporated by reference. The '938 patent discloses vulcanizable rubber compositions containing an uncured rubber and a self-condensing alkylated triazine resin having high imino and/or methylol functionality. U.S. Pat. No. 5,298,539 discloses rubber additives which are substituted derivatives based on cyclic nitrogen compounds such as melamine, acetoguanamine, cyclohexylguanamine, benzoguanamine, and similar alkyl, aryl or aralkyl substituted melamines, glycoluril and oligomers of these compounds. In particular, the adhesive resins and adhesive compounds which are useful as the adhesive resins in the rubber compositions described herein include the following: adhesive resins selected from the group consisting of derivatives of melamine, acetoguanamine, benzoguanamine, cyclohexylguanamine and glycoluril monomers and oligomers of these monomers, which have been substituted on average at two or more positions on the monomer or on each unit of the oligomer with vinyl terminated radicals, the vulcanizable rubber composition being free of resorcinol; and, these derivatives which have been further substituted on average at one or more positions with a radical which comprises carbamylmethyl or amidomethyl.

Further, the adhesive resin can be any of the compounds of the following formulas: 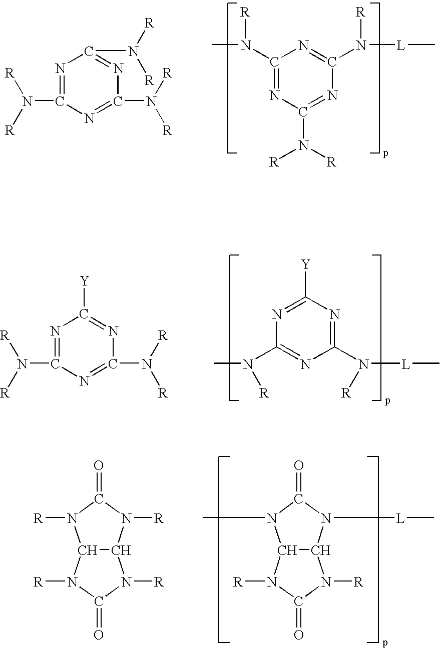
and positional isomers thereof,
wherein, in each monomer and in each polymerized unit of the oligomers, Y is selected from methyl, phenyl and cyclohexyl, and, on average,
at least two R are —CH₂—R¹,
and any remaining R are H, and
at least 2 R¹ are radicals selected from:
   CH₂═C(R²)—C(O)—O—,
   CH₂═C(R²)—C(O)—Z,
   CH₂═C(R²)—C(O)—NH—, and
   CH₂═C(R²)—CH₂—O—,
wherein R² is hydrogen or C₁-C₁₈ alkyl, and Z is a radical selected from:
   —O—CH₂—CH₂—O—,
   —O—CH₂—CH(CH₃)—O—,
   —O—CH₂—CH₂—CH₂O—, and
   —O—CH(C₂H₅)—O—, and
any remaining R¹ radicals are selected from
   —O—R³,
   —NH—C(O)—OR⁴, and
   —NH—C(O)—R⁴, and
wherein R₃ is hydrogen or R₄, and
R₄ is a C₁-C₁₈ alkyl, alicyclic, hydroxyalkyl, alkoxyalkyl or aromatic radical, and in the oligomers,
P is 2 to about 10, and
L is methylene or the radical
   —CH₂—O—CH₂—.
   These adhesive compounds are particularly useful, wherein on average at least one R¹ in each monomer or in each oligomerized unit is —NH—C(O)—OR⁴, particularly the compounds of the following fonnulas:

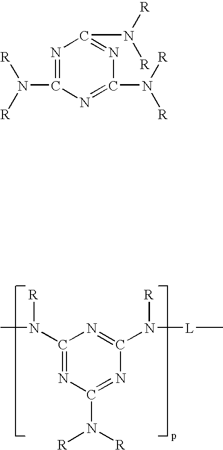

Particularly useful adhesive resins include the above formulas wherein on average, at least one R radical in each monomer or in each oligomerized unit is
—CH₂—NH—C(O)—OR⁴,
wherein R⁴ is a C₁-C₁₈ alkyl, alicyclic, hydroxyalkyl, alkoxyalkyl or aromatic radical, and wherein, on average, at least two R radicals are selected from
CH₂═C(CH₃)—C(O)O—C₃H₆—O—CH₂—
and
CH₂═CH₂—C(O)O—C₂H₄—O—CH₂—
and at least one R radical is selected from
—CH₂—NH—C(O)—O—CH₃, and
—CH₂—NH—C(O)—O—C₃H₇.

These adhesive resins and compounds can include additional additives, particularly those selected from hydroxymethylated and alkoxymethylated (alkoxy having 1-5 carbon atoms) derivatives of melamine, acetoguanamine, benzoguanamine, cyclohexylguanamine and glycoluril and their oligomers.

Additional adhesive resins useful in the rubber compositions described herein include self-condensing alkylated triazine resins selected from the group consisting of (i), (ii), and (iii):

(i) a self-condensing alkylated triazine resin having at least one of imino or methylol functionality and represented by the formula (I)

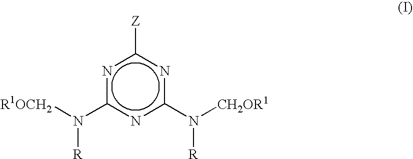

(ii) an oligomer of (i), or

(iii) a mixture of (i) and (ii), wherein

Z is —N(R)(CH₂OR¹), aryl having 6 to 10 carbon atoms, alkyl having 1 to 20 carbon atoms or an acetyl group,

each R is independently hydrogen or —CH₂OR¹, and

each R¹ is independently hydrogen or an alkyl group having 1 to 12 carbon atoms,

provided that at least one R is hydrogen or —CH₂OH and at least one R¹ is selected from the alkyl group; and

wherein the vulcanizable rubber composition is substantially free of methylene acceptor coreactants.

These adhesive resins are particularly useful wherein at least one R group is hydrogen and/or wherein at least one R¹ group is a lower alkyl group having 1 to 6 carbon atoms, particularly where the adhesive resin is a derivative of melamine, benzoguanamine, cyclohexylguanamine, or acetoguanamine, or an oligomer thereof.

One particularly useful alkylated triazine adhesive resin of the above formula is wherein Z is —N(R)(CH₂OR¹).

Another manner of eliminating resorcinol in an adhesive resin for elastomer and rubber compositions, also useful herein, is N-(substituted oxymethyl)melamine and at least one of α- or β-naphthol. This adhesive resin employs the monohydric phenols, α- or β-naphthol, as methylene acceptors in the resin forming reaction during vulcanization in the absence of resorcinol.

Other adhesive resins useful in the elastomer and/or rubber compositions described herein include special latices such as, for example, a vinyl-pyridine latex (VP latex) which is a copolymer of about 70% butadiene, about 15% styrene and about 15% 2-vinylpyridine; acrylonitrile rubber latices; and styrene-butadiene rubber latices. These can be used as such or in combination with one another. Another suitable adhesive resin useful herein, are those which are applied in multi-stage processes, for instance a blocked isocyanate being applied in combination with polyepoxide and the material then being treated using customary resorcinol-formaldehyde resins (RFL dip). Additional useful adhesive resins include combinations of RFL dips with other adhesion-promoting substances such as, for example, a reaction product of triallyl cyanurate, resorcinol and formaldehyde or p-chlorophenol, resorcinol and formaldehyde.

Other suitable adhesive resins for use in the rubber and adhesion promoters described herein include polyurethane resins, epoxy resins, phenol aldehyde resins, polyhydric phenol aldehyde resins, phenol furfural resins, xylene aldehyde resins, urea formaldehyde resins, melamine formaldehyde resins, alkyd resins, polyester resins, and the like.

Typically, in the adhesion promoter systems, at least one ester compound in accordance with formulas I-IV is combined with an adhesive resin in a weight ratio between about 10 parts ester to about 1 part adhesive resin (i.e., a ratio of about 10:1, ester to resin, respectively) and about 1 part ester to about 10 parts resin (i.e., a ratio of about 1:10, ester to resin, respectively). More preferably, the esters are combined with an adhesive resin in a weight ratio between about 4 parts ester to about 1 part adhesive resin and about 1 part ester to about 4 parts resin. Most preferably, the ratio of ester to adhesive resin is approximately one to one in the adhesion promoter systems described herein.

The term “vulcanization” used herein means the introduction of three dimensional cross-linked structures between elastomer and/or rubber molecules. Thus, thiuram vulcanization, peroxide vulcanization, quinoid vulcanization, resin vulcanization, metal salt vulcanization, metal oxide vulcanization, polyamine vulcanization, radiation vulcanization, hexamethylenetetramine vulcanization, urethane cross-linker vulcanization and the like are included in addition to sulfur vulcanization which is usual and most important.

Elastomers and/or rubbers useful in the compositions described herein can be natural elastomers or rubbers (NR) and/or synthetic elastomers or rubbers, and include thermoplastic elastomers and thermoplastic vulcanizates that have elastic properties and can be processed into plastics.

Synthetic elastomers or rubbers include homopolymers of conjugated diene compounds, such as isoprene, butadiene, chloroprene and the like, for example, polyisoprene rubber (IR), polybutadiene rubber (BR), polychloroprene rubber and the like; copolymers of the above described conjugated diene compounds with vinyl compounds, such as styrene, acrylonitrile, vinyl pyridine, acrylic acid, methacrylic acid, alkyl acrylates, alkyl methacrylates and the like, for example, styrene-butadiene copolymeric rubber (SBR), vinylpyridine-butadiene-styrene copolyrneric rubber, acrylonitrile-butadiene copolymeric rubber, acrylic acid-butadiene copolymeric rubber, methacrylic acid-butadiene copolymeric rubber, methyl acrylate-butadiene copolymeric rubber, methyl methacrylate-butadiene copolymeric rubber, acrylonitrile-butadiene-styrene teipolymer, and the like; copolymers of olefins, such as ethylene, propylene, isobutylene and the like with dienes, for example isobutylene-isoprene copolymeric rubber (IIR); copolymers of olefins with non-conjugated dienes (EPDM), for example, ethylene-propylene-cyclopentadiene terpolymer, ethylene-propylene-5-ethylidene-2-norbomene terpolymer and ethylene-propylene-1,4-hexadiene terpolymer; polyalkenamer obtained by ring opening polymerization of cycloolefins, for example, polypentenamer; rubbers obtained by ring opening polymerization of oxirane ring, for example, polyepichlorohydrin rubber and polypropylene oxide rubber which can be vulcanized with sulfur, silicone rubbers, and the like. Furthermore, halides of the above-described various rubbers, for example, chlorinated isobutylene-isoprene copolymeric rubber (CI-IIR), brominated isobutylene-isoprene copolymeric rubber (Br-IIR), fluorinated polyethylene, and the like are included.

Particularly, the compositions described herein are characterized in that the surfaces of the vulcanized elastomers and/or rubbers of natural rubber (NR), and synthetic rubbers, e.g. styrene-butadiene copolymeric rubber (SBR), polybutadiene rubber (BR), polyisoprene rubber (IR), isobutylene-isoprene, copolymeric rubber, halides of these rubbers (CI-IIR, Br-IIR) and copolymers (EPDM) of olefins with non-conjugated dienes, which are poor in the adhering ability, are improved to provide them a high adhering ability. Of course, the present invention can be applied to the other rubbers. All these rubbers may be kneaded with compounding agents conventionally used for compounding with rubber, for example, fillers, such as carbon black, silica, calcium carbonate, lignin and the like, softening agents, such as mineral oils, vegetable oils, prior to the vulcanization and then vulcanized.

Examples of thermoplastic elastomers include styrenic thermoplastic elastomers, such as styrenic block copolymers (SBCs); e.g., SEBS—styrene-ethylene-butylene-styrene); thermoplastic olefins (TPOs); thermoplastic polyurethane elastomers (TPUs); copolyesters (COPEs); copolyamides (COPAs); thermoplastic elastomers based on halogen-containing polyolefins; dynamically vulcanized elastomer-thermoplastic blends; thermoplastic polyether ester elastomers; ionomeric thermoplastic elastomers e.g., Surlyn® and related polymers; KELTAN® (EPDM rubber and polypropylene); ionomeric thermoplastic elastomers; and polyaceylate-based thermoplastic elastomers. Additional examples of thermoplastic elastomers and thermoplastic vulcanizates, and products they can be used to procedure, can be found in Thermoplastic Elastomers, P. W. Dutton, 2002 (166 pages), hereby incorporated by reference.

Fluorinated elastomers include Viton-E® and Kalrez®; Teflon® (polytetrafluoroethylene); and fluorinated silicone materials, e.g., polytrifluropropyl methyl siloxane, particularly useful for O-rings, pump and agitation shaft no chain cal-seals; transfer hose materials; gasket materials; chemical pumps, and the like.

The vulcanized rubbers, the surface of which has been treated with the adhesion promoter systems described herein can be easily adhered to the other materials, together with an adhesive resin, particularly metals and polymers, particularly in cord form.

In order to cure a rubber composition a vulcanizing agent such as a sulfur or peroxide vulcanizing agent is dispersed throughout the composition. The vulcanizing agent may be used in an amount ranging from 0.5 to 6.0%, based on the weight of the natural and/or synthetic rubbers in the composition, with a range of from 1.0 to 4.0% being preferred. Representative examples of sulfur vulcanizing agents include elemental sulfur (S₈), an amine disulfide, polymeric polysulfide and sulfur olefin adducts. Preferably, the sulfur vulcanizing agent is elemental sulfur.

Other suitable vulcanizing agents include thiuram, quinoid, metal salt, metal oxide, polyamine, vulcanization, radiation, hexamethylenetetramine, urethane cross-linker, and the like. Typical examples of peroxide vulcanizing agents include dibenzoyl peroxide and di(tertiary-butyl)peroxide.

The commonly employed carbon blacks used in conventional rubber compounding applications can be used as the carbon black in this invention. Representative examples of such carbon blacks include N110, N121, N220, N231, N234, N242, N293, N299, S315, N326, N330, M332, N339, N343, N347, N351, N358 and N375.

The elastomer and/or rubber compositions described herein are compounded by methods generally known in the rubber compounding art, such as mixing the various sulfur-vulcanizable or peroxide-vulcanizable constituent rubbers with various commonly used additive materials such as, for example, sulfur donors, curing aids, such as activators and retarders and processing additives, such as oils, resins including tackifying resins and plasticizers, fillers, pigments, fatty acid, zinc oxide, waxes, antioxidants and antiozonants, retarders and peptizing agents. As known to those skilled in the art, the additives mentioned above are selected and commonly used in conventional amounts for tire tread applications. Typical amount of adhesive resins, comprise about 0.2 to about 10%, based on the weight of natural and/or synthetic rubbers, usually about 1 to 5%.

Typical amounts of zinc oxide comprise about 2 to about 5%. Typical amounts of waxes comprise about 1 to about 5% based on the weight of natural and/or synthetic rubbers. Often microcrystalline waxes are used. Typical amounts of retarders range from 0.05 to 2%. Typical amounts of peptizers comprise about 0.1 to 1%. Typical peptizers may be, for example, pentachlorothiophenol and dibenzamidodiphenyl disulfide. All additive percentages are based on the weight of natural and/or synthetic rubbers.

Accelerators may be used to control the time and/or temperature required for vulcanization and to improve the properties of the vulcanizate. The accelerator(s) may be used in total amounts ranging from about 0.5 to about 4%, preferably about 0.8 to about 1.5%, based on the weight of natural and/or synthetic rubbers. Suitable types of accelerators that may be used are amines, disulfides, guanidines, thioureas, thiazoles, thiurams, sulfenamides, dithiocarbamates and xanthates. If included in the rubber composition, the primary accelerator preferably is a sulfenamide. If a second accelerator is used, the secondary accelerator is preferably a guanidine, dithiocarbamate or thiuram compound.

The adhesion promoters described herein are especially effective in compositions in which the rubber is cis-polyisoprene, either natural or synthetic, and in blends containing at least 25% by weight of cis-polyisoprene with other rubbers. Preferably the rubber, if a blend, contains at least 40% and more preferably at least 60% by weight of cis-polyisoprene. Examples of other rubbers which may be blended with cis-polyisoprene include poly-1,3-butadiene, copolymers of 1,3-butadiene with other monomers, for example styrene, acrylonitrile, isobutylene and methyl methacrylate, ethylene/propylene/diene terpolymers, and halogen-containing rubbers such as chlorobutyl, bromobutyl and chloroprene rubbers.

The amount of sulphur in the composition is typically from 2 to 8 parts, for example from 3 to 6, by weight per 100 parts by weight of rubber, but lesser or larger amounts, for example from 1 to 7 or 8 parts on the same basis, may be employed. A preferred range is from 2.5 to 6 parts per 100 parts by weight of rubber.

Additional examples of vulcanization accelerators which can be used in the rubber compositions described herein are the thiazole-based accelerators, for example 2-mercaptobenzothiazole, bis(2-benzothiazolyl)disulphide, 2(2′,4′-dinitrophenyl-thio)benzothiazole, benzothiazole-2-sulphenamides for instance N-isopropylbenzothiazole-2-sulphenamide, N-tert-butyl-benzothiazole-2-sulphenamide, N-cyclohexylbenzo-thiazole-2-sulphenamide, and 2(morpholinothio)benzothiazole, and thiocarbamylsulphenamides, for example N,N-dimethyl-N′,N′-dicyclohexylthiocarbamoyl-sulphenamide and N(morpholinothiocarbonylthio)-morpholine. A single accelerator or a mixture of accelerators may be used. In the compositions described herein, these vulcanization accelerators are usually used in amounts of from 0.3 to 2, for example from 0.3 to 1.5, preferably from 0.4 to 1.0 and more preferably from 0.5 to 0.8, parts by weight per 100 parts by weight of rubber.

The long chain ester additive/resin combinations (i.e., adhesion promoter systems) described herein are particularly useful to adhere elastomer layers of substantially differing polarities, e.g., one being a fluorinated elastomer as an inner, chemical resistance layer, where conventional adhesive pretreatment has been largely ineffective.

Vulcanization of the elastomer and/or rubber compositions described herein is generally carried out at conventional temperatures ranging from about 100° C. to 200° C. Preferably, the vulcanization is conducted at temperatures ranging from about 110° C. to 180° C. Any of the usual vulcanization processes may be used such as heating in a press or mold, heating with superheated steam or hot air or in a salt bath.

Upon vulcanization of the elastomer and/or rubber composition at a temperature ranging from 100° C. to 200° C., the composition can be used for various purposes. For example, the vulcanized rubber composition may be in the form of a tire, belt, hose, motor mount, gasket and air spring. In the case of a tire, it can be used for various tire components. Such tires can be built, shaped, molded and cured by various methods which are known and will be readily apparent to those having skill in such art. When the rubber composition is used in a tire, its use may be in a wire coat, bead coat, tread, apex, sidewall and combination thereof. As can be appreciated, the tire may be a passenger tire, aircraft tire, truck tire, and the like. Preferably, the tire is a passenger tire. The tire may also be a radial or bias, with a radial tire being preferred.

What is claimed is:

1. A multi-layer vulcanized elastomer or rubber article including a plurality of layers of a cross-linked or vulcanized elastomer or rubber adhered together with an adhesion promoter, disposed within or on at least one elastomer/rubber layer, wherein the adhesion promoter comprises: (1) an adhesive resin in an amount of about 0.1% to about 15% by weight, based on the weight of rubber in the composition; and (2) an ester having formula I, II, III, IV or a combination of any two or more of said esters in an amount of about 0.1% to about 15% by weight, based on the weight of rubber in the composition: 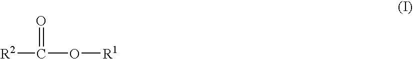
wherein R¹ is a C₃-C₂₄ alkyl radical, straight chain or branched, saturated, or unsaturated containing 1 to 3 carbon-to-carbon double bonds; R² is a C₆-C₂₄ saturated fatty acid residue, or an unsaturated fatty acid residue having 1 to 6 carbon-to-carbon double bonds; 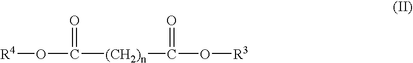
wherein n=3-24, and R³ and R⁴, same or different, are a C₃-C₂₄ alkyl radical, straight chain or branched, saturated, or unsaturated containing 1 to 3 carbon-to-carbon double bonds; 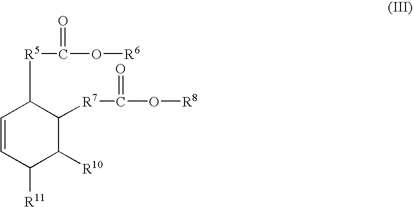
wherein R⁵ and R⁷, same or different, are a C₃-C₂₄ hydrocarbon chain, straight chain or branched, either saturated or having 1 to 6 carbon-to-carbon double bonds;
R⁶ and R⁸, same or different, are C₃-C₂₄ alkyl radical, straight chain or branched, saturated, or unsaturated containing 1 to 3 carbon-to-carbon double bonds; and
R¹⁰ and R¹¹, same or different, are a C₃-C₂₄, saturated hydrocarbon chain, straight chain or branched; or an unsaturated C₃-C₂₄, hydrocarbon chain, straight chain or branched, having 1 to 6, carbon-to-carbon double bonds; 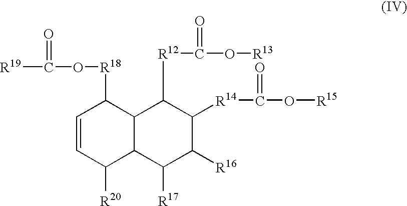
wherein R¹², R¹⁴ and R¹⁸, same or different, are a C₃-C₂₄, hydrocarbon chain, straight chain or branched, either saturated or having 1 to 6 carbon-to-carbon double bonds;
R¹³, R¹⁵ and R¹⁹, same or different, are a C₃-C₂₄ alkyl radical, straight chain or branched, saturated, or unsaturated containing 1 to 3 carbon-to-carbon double bonds; and
R¹⁶, R¹⁷ and R²⁰, same or different, are a C₃-C₂₄ saturated hydrocarbon chain, straight chain or branched; or unsaturated C₃-C₂₄ hydrocarbon chain, straight chain or branched, containing 1 to 6 carbon-to-carbon double bonds.

2. A multi-layer elastomer/rubber article in accordance with claim 1, wherein the ester is selected from the group consisting of formula I, II, III, IV, and a combination of any two or more of said esters: 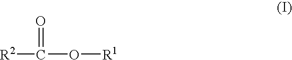
wherein R¹ is a C₃-C₁₈ alkyl radical, straight chain or branched, saturated, or unsaturated containing 1 to 3 carbon-to-carbon double bonds; and R² is a C₈-C₁₈ saturated fatty acid residue, or an unsaturated fatty acid residue having 1 to 3 carbon-to-carbon double bonds; 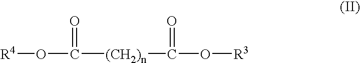
wherein n=6-18, and R³ and R⁴, same or different, are a C₃-C₁₈ alkyl radical, straight chain or branched, saturated, or unsaturated containing 1 to 3 carbon-to-carbon double bonds; 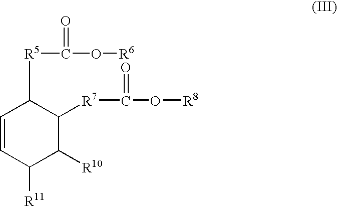
wherein R⁵ and R⁷, are a C₆-C₂₄ hydrocarbon chain, straight chain or branched; either saturated or having 1 to 3 carbon-to-carbon double bonds;
R⁶ and R⁸, same or different, are a C₃-C₁₈ alkyl radical, straight chain or branched, saturated, or unsaturated containing 1 to 3 carbon-to-carbon double bonds; and
R¹⁰ and R¹¹, same or different, are a C₃-C₁₈, saturated hydrocarbon chain, straight chain or branched; or an unsaturated hydrocarbon chain, straight chain or branched, containing 1 to 3 carbon-to-carbon double bonds; 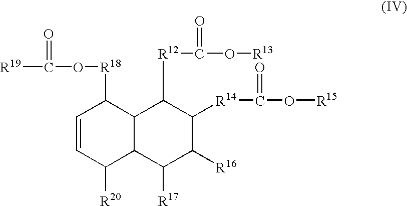
wherein R¹², R¹⁴ and R¹⁸, same or different, are a C₈-C₁₈, hydrocarbon chain, straight chain or branched, either saturated or having 1 to 3 carbon-to-carbon double bonds;
R¹³, R¹⁵ and R¹⁹, same or different, are a C₆-C₁₈ alkyl radical, straight chain or branched, saturated, or unsaturated containing 1 to 3 carbon-to-carbon double bonds; and
R¹⁶, R¹⁷ and R²⁰, same or different, are a C₆-C₁₈ saturated hydrocarbon chain, straight chain or branched; or an unsaturated C₆-C₁₈ hydrocarbon-chain, straight chain or branched, containing 1 to 3 carbon-to-carbon double bonds.

3. The multi-layer elastomer/rubber article of claim 1, wherein the adhesive resin is a condensation product of a methylene acceptor and a methylene donor.

4. The multi-layer elastomer/rubber article in accordance with claim 3, wherein the adhesive resin is selected from the group consisting of phenol-formaldehyde, melamine-formaldehyde; naphthol-formaldehyde; polyepoxide; a reaction product of triallyl cyanurate, resorcinol, and formaldehyde; a reaction product of p-chlorophenol, resorcinol, and formaldehyde; a copolymer of styrene, butadiene, and 2-vinylpyridine; and mixtures thereof.

5. The multi-layer elastomer/rubber article in accordance with claim 4, wherein the phenol-formaldehyde resin is resorcinol-formaldehyde.

6. The multi-layer elastomer/rubber article in accordance with claim 1, wherein the adhesive resin is selected from the group consisting of derivatives of melamine, acetoguanamine, benzoguanamine, cyclohexylguanamine and glycoluril monomers and oligomers of these monomers, which have been substituted on average at two or more positions on the monomer or on each unit of the oligomer with vinyl terminated radicals, the rubber composition being free of resorcinol.

7. The multi-layer elastomer/rubber article in accordance with claim 6, wherein at least one of the adhesive resins has been further substituted at one or more positions with a radical which comprises carbamoylmethyl or amidomethyl.

8. The multi-layer elastomer/rubber article in accordance with claim 6, wherein the adhesive resin is selected from compounds of the formula: 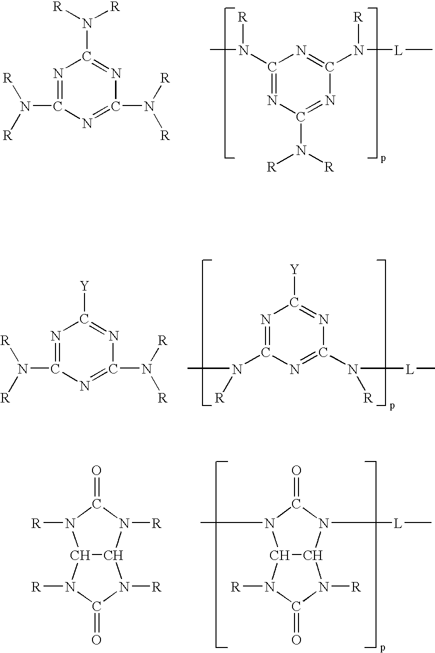
and positional isomers thereof,
wherein, in each monomer and in each polymerized unit of the oligomers, Y is selected from methyl, phenyl and cyclohexyl, and at least two R are —CH₂—R¹, and any remaining R are H, and at least 2 R¹ are radicals selected from
CH₂═C(R²)—C(O)—O—,
CH₂═C(R²)—C(O)-Z,
CH₂═C(R²)—C(O)—NH—, and
CH₂═C(R²)—CH₂—O—,
wherein R² is hydrogen or C₁-C₁₈ alkyl, and Z is a radical selected from
—O—CH₂—CH₂—O—,
—O—CH₂—CH(CH₃)—O—,
—O—CH₂—CH₂—CH₂O—, and
—O—CH(C₂H₅)—O—, and
any remaining R¹ radicals are selected from
—O—R³,
—NH—C(O)—OR⁴, and
—NH—C(O)—R⁴, and
wherein R₃ is hydrogen or R₄, and R₄ is a C₁-C₁₈ alkyl, alicyclic, hydroxyalkyl, alkoxyalkyl or aromatic radical, and in the oligomers, P is 2 to about 10, and L is methylene or the radical
—CH₂—O—CH₂—

9. The multi-layer elastomer/rubber article in accordance with claim 8, wherein at least one R¹ in each monomer or in each oligomerized unit of the adhesive resin is:
—NH—C(O)—OR⁴
wherein R⁴ is as defined in claim 8.

10. The multi-layer elastomer/rubber article in accordance with claim 9, wherein the adhesive resin is a compound of the formula 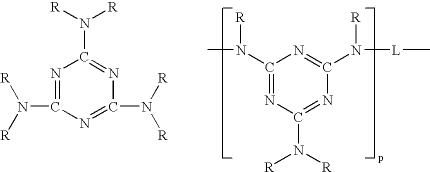
wherein P is 2 to about 10, L is methylene or the radical —CH₂—O—CH₂—, and R is as follows:
at least two R are —CH₂—R¹, and any remaining R are H, and at least 2 R¹ are radicals selected from
CH₂═C(R²)—C(O)—O—,
CH₂═C(R²)—C(O)-Z,
CH₂═C(R²)—C(O)—NH—, and
CH₂═C(R²)—CH₂—O—,
wherein R² is hydrogen or C₁-C₁₈ alkyl, and Z is a radical selected from
—O—CH₂—CH₂—O—,
—O—CH₂—CH(CH₃)—O—,
—O—CH₂—CH₂—CH₂O—, and
—O—CH(C₂H₅)—O—, and
any remaining R¹ radicals are selected from
—O—R³,
—NH—C(O)—OR⁴, and
—NH—C(O)—R⁴, and
wherein R₃ is hydrogen or R₄, and R₄ is a C₁-C₁₈ alkyl, alicyclic, hydroxyalkyl, alkoxyalkyl or aromatic radical.

11. The multi-layer elastomer/rubber article in accordance with claim 10, wherein in the adhesive resin formulas, on average at least one R radical in each monomer or in each oligomerized unit is
—CH₂—NH—C(O)—OR⁴
wherein R⁴ is a C₁-C₁₈ alkyl, alicyclic, hydroxyalkyl, alkoxyalkyl or aromatic radical.

12. The multi-layer elastomer/rubber article in accordance with claim 10, wherein on average at least two R radicals are selected from
CH₂═C(CH₃)—C(O)O—C₃H₆—O—CH₂—
and
CH₂═CH₂—C(O)O—C₂H₄O—CH₂—
and at least one R radical is selected from
CH₂—NH—C(O)—O—CH₃
and
CH₂—NH—C(O)—O—C₃H₇.

13. The multi-layer elastomer/rubber article in accordance with claim 8, further comprising an additional additive selected from hydroxymethylated and alkoxymethylated derivatives of melamine, acetoguanamine, benzoguanamine, cyclohexylguanamine and glycoluril and their oligomers.

14. The multi-layer elastomer/nibber article in accordance with claim 6, wherein the adhesive resin comprises melamine or an oligomer of melamine.

15. The multi-layer elastomer/rubber article in accordance with claim 6, wherein the adhesive resin comprises acetoguanamine or an oligomer of acetoguanamine.

16. The multi-layer elastomer/rubber article in accordance with claim 6, wherein the adhesive resin comprises benzoguanamine or an oligomer of benzoguanamine.

17. The multi-layer elastomer/rubber article in accordance with claim 6, wherein the adhesive resin comprises cyclohexylguanamine or an oligomer of cyclohexylguanamine.

18. The multi-layer elastomer/rubber article in accordance with claim 1, wherein the adhesive resin is a self-condensing alkylated triazine resin selected from the group consisting of (i), (ii), and (iii):
(i) a self-condensing alkylated triazine resin having at least one of imino or methylol functionality and represented by formula (1) 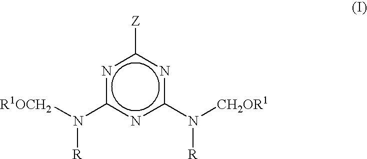
(ii) an oligomer of (i), or
(iii) a mixture of (i) and (ii), wherein
Z is —N(R)(CH₂OR¹), aryl having 6 to 10 carbon atoms, alkyl having 1 to 20 carbon atoms or an acetyl group,
each R is independently hydrogen or —CH₂OR¹, and
each R¹ is independently hydrogen or an alkyl group having 1 to 12 carbon atoms,
provided that at least one R is hydrogen or —CH₂OH and at least one R¹ is selected from the alkyl group; and
wherein the rubber composition is substantially free of methylene acceptor coreactants.

19. The multi-layer elastomer/rubber article in accordance with claim 18, wherein at least one R group of the alkylated triazone resin is hydrogen.

20. The multi-layer elastomer/rubber article in accordance with claim 19, wherein at least one R¹ group of the alkylated triazone resin is a lower alkyl group having 1 to 6 carbon atoms.

21. The multi-layer elastomer/rubber article in accordance with claim 20, wherein the adhesive resin is a derivative of melamine, benzoguanamine, cyclohexylguanamine, or acetoguanamine, or an oligomer thereof.

22. The multi-layer elastomer/rubber article in accordance with claim 20, wherein Z is —N(R)(CH₂OR¹).

23. The multi-layer elastomer/rubber article in accordance with claim 4, wherein the phenol-formaldehyde resin is resorcinol-formaldehyde; and the melamine-formaldehyde resin is N-(substituted oxymethyl) melamine-formaldehyde.

24. The multi-layer elastomer/rubber article in accordance with claim 1, wherein the ester has the formula II and comprises a saturated diester formed by the reaction of sebacic acid and a C₆-C₂₄ alcohol, straight chain or branched, saturated, or unsaturated containing 1 to 3 carbon-to-carbon double bonds.

25. The multi-layer elastomer/rubber article in accordance with claim 24, wherein the alcohol is 2-ethylhexyl alcohol, and the ester has the following formula:

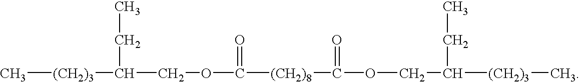

26. The multi-layer elastomer/rubber article in accordance with claim 1, wherein the ester is an unsaturated diester formed by the reaction of a C₃₆ dimer acid and a C₃-C₁₈ alcohol, straight chain or branched, saturated, or unsaturated containing 1 to 3 carbon-to-carbon double bonds.

27. The multi-layer elastomer/rubber article in accordance with claim 26, wherein the alcohol is 2-ethylhexyl alcohol.

28. The multi-layer elastomer/rubber article in accordance with claim 26, wherein the alcohol is tridecyl alcohol.

29. The multi-layer elastomer/rubber article in accordance with claim 26, wherein the alcohol is oleyl alcohol.

30. The multi-layer elastomer/rubber article in accordance with claim 1, wherein the ester comprises the following dimer acid reacted with a C₃-C₂₄ alcohol:

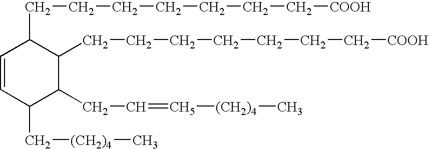

31. The multi-layer elastomer/rubber article in accordance with claim 1, wherein the ester comprises the following dimer acid reacted with a C₃-C₂₄ alcohol:

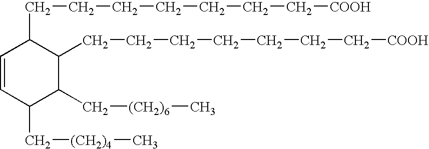

32. The multi-layer elastomer/rubber article in accordance with claim 1, wherein the ester comprises the following dimer acid reacted with a C₃-C₂₄ alcohol:

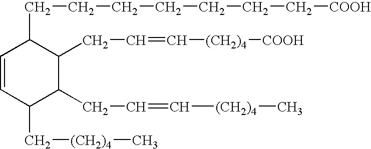

33. The multi-layer elastomer/rubber article in accordance with claim 1, wherein the ester is the reaction product of a C₃-C₂₄ alcohol with a tricarboxylic acid, having the following formula:

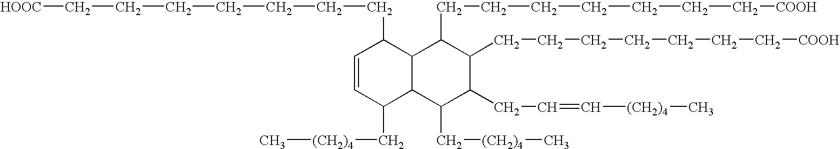

34. The multi-layer elastomer/rubber article in accordance with claim 1, wherein the ester is a combination of compounds of formula I, II, III, and IV.

35. The multi-layer elastomer/rubber article in accordance with claim 34, wherein the ester is a reaction product of a C₃-C₂₄ alcohol straight chain or branched, saturated, or unsaturated having 1 to 3 carbon-to-carbon double bonds, with a dimer acid having CAS #61788-89-4.

36. The multi-layer elastomer/rubber article in accordance with claim 35, wherein the alcohol is 2-ethylhexyl alcohol.

37. The multi-layer elastomer/rubber article in accordance with claim 35, wherein the alcohol is a tridecyl alcohol.

38. The multi-layer elastomer/rubber article in accordance with claim 35, wherein the alcohol is an oleyl alcohol.

39. The multi-layer elastomer/rubber article in accordance with claim 1, wherein the R², R⁵, R⁷, R¹², R¹⁴ are fatty acid residues derived from animal or vegetable fatty acids.

40. The multi-layer elastomer/rubber article of claim 39, wherein the fatty acids are selected from the group consisting of butter; lard; tallow; grease; herring; menhaden; pilchard; sardine; babassu; castor; coconut; corn; cottonseed; jojoba; linseed; oiticia; olive; palm; palm kernel; peanut; rapeseed; safflower; soya; sunflower; tall; tung; and mixtures thereof.

41. The multi-layer elastomer/rubber article of claim 40, wherein the fatty acid residues are selected from the group consisting of hexanoic; octanoic; decanoic; dodecanoic; 9-dodecenoic; tetradecanoic; 9-tetradecenoic; hexadecanoic; 9-hexadecenoic; octadecanoic; 9-octadecenoic; 9-octadecenoic, 12-hydroxy; 9,12-octadecadienoic; 9,12,15-octadecatrienoic; 9,11,13-octadecatrienoic; 9,11,13-octadecatrienoic, 4-oxo; octadecatetrenoic; eicosanoic; 11-eicosenoic; eicosadienoic; eicosatrienoic; 5,8,11,14-eicosatetraenoic; eicosapentaenoic; docosanoic; 13-docosenoic; docosatetraenoic; 4,8,12,15,19-docosapentaenoic; docosahexaenoic; tetracosenoic; and 4,8,12,15,18,21-tetracosahexaenoic.

42. A method of adhering one cross-linked or vulcanized elastomer layer to another cross-linked or vulcanized elastomer layer, comprising applying, to a surface of at least one of the elastomer layers, or in an elastomer-containing composition from which at least one of the cross-linked or vulcanized elastomer layers was formed, an adhesion promoter comprising an adhesive resin and a liquid ester additive of formula I, II, III, IV, or mixtures thereof: 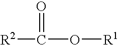
wherein R¹ is a C₃-C₂₄ alkyl radical, straight chain or branched, saturated, or unsaturated containing 1 to 3 carbon-to-carbon double bonds; R² is a C₆-C₂₄ saturated fatty acid residue, or an unsaturated fatty acid residue having 1 to 6 carbon-to-carbon double bonds; 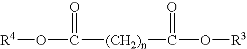
wherein n=3-24 and R³ and R⁴, same or different, are a C₃-C₂₄ alkyl radical, straight chain or branched; 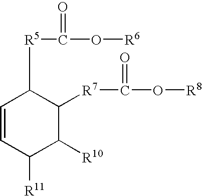
wherein R⁵ and R⁷, same or different, are a C₃-C₂₄ hydro carbon chain, straight chain or branched, either saturated or having 1 to 6 carbon-to-carbon double bonds;
R⁶ and R⁸, same or different, are a C₃-C₂₄ alkyl radical, straight chain or branched; and
R¹⁰ and R¹¹, same or different, are a C₃-C₂₄, saturated hydrocarbon chain, straight chain or branched; or an unsaturated C₃-C₂₄, hydrocarbon chain, straight chain or branched, having 1 to 6 carbon-to-carbon double bonds; 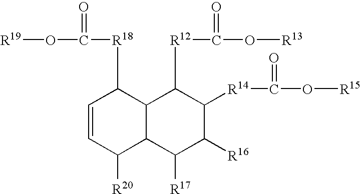
wherein R¹², R¹⁴ and R¹⁸, same or different, are a C₃-C₂₄ hydrocarbon chain, straight chain or branched, either saturated or having 1 to 6 carbon-to-carbon double bonds;
R¹³, R¹⁵ and R¹⁹, same or different, are C₃-C₂₄ alkyl radical, straight chain or branched, saturated, or unsaturated containing 1 to 3 carbon-to-carbon double bonds; and
R¹⁶, R¹⁷ and R²⁰, same or different, are C₃-C₂₄ saturated hydrocarbon chain, straight chain or branched; or unsaturated C₃-C₂₄ hydrocarbon chain, straight chain or branched, containing 1 to 6 carbon-to-carbon double bonds; and
pressing the adhesion promoter-containing elastomer layer to the other elastomer layer until the two layers are adhered together.

43. A method in accordance with claim 42, wherein both elastomer layers have the adhesion promoter applied to a surface, and pressing both adhesion promoter-applied surfaces together.

44. A method of adhering one elastomer or rubber layer to another elastomer or rubber layer comprising an expedient selected from the group consisting of (1) applying a liquid adhesion promoter comprising an adhesive resin component and an ester component to a surface of at least one of the elastomer or rubber layers prior to contacting the layers together at the applied adhesion promoter; (2) contacting a surface of at least one of the elastomer or rubber layers separately with a solvent solution or water-based emulsion containing the ester component of the liquid adhesion promoter, and contacting a surface of at least one of the elastomer or rubber layers separately with a solvent solution or water-based emulsion containing the adhesive resin component of the liquid adhesion promoter prior to contacting the layers together at the applied adhesion promoter; (3) applying the adhesive resin component of the liquid adhesion promoter to a surface of at least one of the elastomer or rubber layers prior to contacting the adhesive resin-applied elastomer or rubber layer with the other elastomer or rubber layer containing a surface-applied solvent solution or water-based emulsion containing the ester component of the liquid adhesion promoter; (4) applying the ester component of the liquid adhesion promoter to a surface of at least one of the elastomer or rubber layers prior to contacting the ester-applied elastomer or rubber layer with a solvent solution or water-based emulsion containing the adhesive resin component of the liquid adhesion promoter; wherein the ester component of the adhesion promoter is selected from the group consisting of formulas I, II, III, IV, and a combination of any two or more: 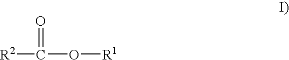
wherein R¹ is a C₃-C₂₄ alkyl radical, straight chain or branched, saturated, or unsaturated containing 1 to 3 carbon-to-carbon double bonds; R² is a C₃-C₂₄ saturated fatty acid residue, or an unsaturated fatty acid residue having 1 to 6 carbon-to-carbon double bonds; 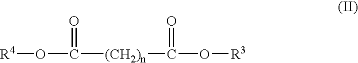
wherein n=3-24, and R³ and R⁴, same or different, are a C₃-C₂₄ alkyl radical, straight chain or branched, saturated, or unsaturated containing 1 to 3 carbon-to-carbon double bonds; 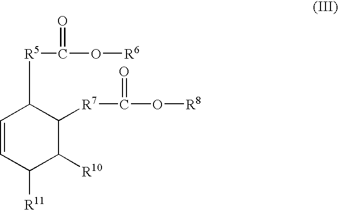
wherein R⁵ and R⁷, same or different, are a C₃-C₂₄ hydrocarbon chain, straight chain or branched, either saturated or having 1 to 6 carbon-to-carbon double bonds;
R⁶ and R⁸, same or different, are C₃-C₂₄ alkyl radical, straight chain or branched, saturated, or unsaturated containing 1 to 3 carbon-to-carbon double bonds; and
R¹⁰ and R¹¹, same or different, are a C₃-C₂₄, saturated hydrocarbon chain, straight chain or branched; or an unsaturated C₃-C₂₄, hydrocarbon chain, straight chain or branched, having 1 to 6, carbon-to-carbon double bonds; 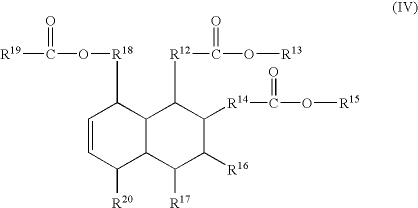
wherein R¹², R¹⁴ and R¹⁸, same or different, are a C₃-C₂₄, hydrocarbon chain, straight chain or branched, either saturated or having 1 to 6 carbon-to-carbon double bonds;
R¹³, R¹⁵ and R¹⁹, same or different, are a C₃-C₂₄ alkyl radical, straight chain or branched, saturated, or unsaturated containing 1 to 3 carbon-to-carbon double bonds; and
R¹⁶, R¹⁷ and R²⁰, same or different, are a C₃-C₂₄ saturated hydrocarbon chain, straight chain or branched; or unsaturated C₃-C₂₄ hydrocarbon chain, straight chain or branched, containing 1 to 6 carbon-to-carbon double bonds.

45. A method in accordance with claim 44, wherein the weight ratio of the adhesive resin component applied to ester applied is in the range of about 1 to 4 and 4 to 1.

46. The method of claim 44, wherein the rubber layers are vulcanized prior to applying the ester and adhesive resin components of the adhesion promoter.
